(19) United States
(12) Patent Application Publication
(10) Pub. No.: US 2015/0046531 A1
(43) Pub. Date: Feb. 12, 2015

(54) MESSAGING SYSTEM, TOPIC MANAGEMENT DEVICE, MESSAGING METHOD, AND PROGRAM

(71) Applicant: NEC Corporation, Tokyo (JP)

(72) Inventor: Yoshiaki Sakae, Tokyo (JP)

(21) Appl. No.: 14/380,939

(22) PCT Filed: Dec. 18, 2012
(86) PCT No.: PCT/JP2012/082770

§ 371 Date: Aug. 26, 2014

(30) Foreign Application Priority Data
Mar. 26, 2012 (JP) 2012-069899

(51) Int. Cl. H04L 29/08

(52) U.S. Cl. CPC H04L 67/1095
USPC 709/204

(57) ABSTRACT

When a specific message flow is formed among a plurality of processes, process insertion and removal are facilitated. A topic management device includes a correspondence table storage unit which stores correspondence data which associates an abstract topic which is a topic described in a program with a real topic which is a topic for controlling message transmission and reception for each process to be executed by a processing device, and a topic management service control unit which transmits the correspondence data to the processing device. The processing device includes a topic lookup unit which receives the correspondence data from the topic management device, and a message processing unit which transmits and receives a message using the real topic corresponding to the abstract topic described in the program of a process to be executed based on the correspondence data received in the topic lookup unit.

### TECHNICAL FIELD

The present invention relates to a messaging system, a topic management device, a messaging method, and a program.

### BACKGROUND ART

Examples of a Publish-Subscribe (Pub-Sub) messaging model are described in Non-Patent Documents 1 to 3. FIG. 7 illustrates an outline of the Pub-Sub messaging models described in Non-Patent Documents 1 to 3. As illustrated in FIG. 7, the Pub-Sub messaging model is one of the messaging models supported by RabbitMQ (e.g., see Non-Patent Document 4), which is one implementation of Advanced Message Queuing Protocol (AMQP). The Pub-Sub messaging model includes a publisher P which transmits a message, subscribers C1 and C2 which receive the message, queues Q1 and Q2 which implement asynchronous communication between the publisher P and the subscribers C1 and C2, and a broker X which delivers the message from the publisher P to the subscribers C1 and C2 subscribed and registered in advance.

Message delivery is performed using matching of a topic (denoted by “*.orange.*,” “*.*.rabbit,” and “lazy.#” in the example illustrated in FIG. 7) which is added to the message. That is, the subscribers C1 and C2 inform the broker X of topics desired to receive in advance. In addition, when transmitting a message, the publisher P adds a topic to the message and transmits the message to the broker X. The broker X refers to the topic added to the received message and delivers the message to the queues Q1 and Q2 corresponding to the subscribers C1 and C2 subscribing to this topic. The subscribers C1 and C2 receive the delivered message by periodically monitoring the queues Q1 and Q2.

A more specific example in which the subscriber C1 subscribes to the topic “*.orange.*” and the subscriber C2 subscribes to the topics “*.*.rabbit” and “lazy.#” will be described. When the publisher P has added the topic “quick.orange.rabbit” to the message and transmitted the message, the message is delivered to both the subscribers C1 and C2. In contrast, when the publisher P has added the topic “lazy.pink.rabbit” and has transmitted the message, the message is delivered only to the subscriber C2. Here, the symbols ‘*’ and ‘#’ represent wildcards, and a description thereof is omitted because these matching rules depend upon implementation and they are not related to the present invention.

### PRIOR ART DOCUMENTS

### Non-Patent Documents

Non-Patent Document 1: “Publish-subscribe pattern.” [online], [retrieved on Mar. 4, 2012], the Internet <URL: http://en.wikipedia.org/wiki/Publish/subscribe>
Non-Patent Document 2: “Cosminexus application server V8,” [online], Hitachi, Ltd., [retrieved on Mar. 4, 2012], the Internet <http://www.hitachi.co.jp/Prod/comp/soft1/manual/pc/d3U0740/EU070377.HTM>
Non-Patent Document 3: “RabbitMQ,” [online], VMware, [retrieved on Mar. 4, 2012], Internet <http://www.rabbitmq.com/tutorials/tutorial-five-java.html>
Non-Patent Document 4: “RabbitMQ,” [online], VMware, [retrieved on Mar. 4, 2012], Internet <http://www.rabbitmq.com/>

### SUMMARY OF INVENTION

### Problems to be Solved by the Invention

However, when there are a plurality of processing entities and a specific messaging flow among the plurality of processing entities is realized by the Pub-Sub messaging model technologies described in Non-Patent Documents 1 to 4 have a problem in that it is not easy to insert or remove a process.

This will be specifically described with reference to FIG. 8. In an example illustrated in FIG. 8, the following message flow of processes 1 to 3 is formed. The process 1 adds a topic “A” to a message and transmits the message. The process 2 subscribes to the topic “A”, receives the message, applies a given process thereto, adds a topic “B” to the resulting message, and transmits the message. The process 3 subscribes to the topic “B”, receives its message, and applies a given process thereto. When this message flow is formed, it is not easy to insert a process 2.5 between the processes 2 and 3 and to delete either of these processes.

This is because a topic for determining delivery of a message is designated in a program and thus in order to insert or remove a process it is necessary to change topics to be added to messages to be transmitted and to change topics to which a subscription is to be made with respect to processes before and after an insertion or removal position. That is, a program of the process has to be changed in order to insert or remove a process. In addition, the fact that the correspondence of transmission and reception is managed in the brain of a programmer is also a factor of difficulty.

Furthermore, loose coupling, which is one of the merits of the messaging system of the Pub-Sub messaging model, enables processing components to be independently developed. Thus, there is a possibility that processes have been developed by different programmers or different organizations. In this case, the fact that it is difficult to change source codes of programs makes the insertion and removal of a process into and from a message flow more difficult.

The present invention has been made in view of the above-described points, and an exemplary object thereof is to provide a messaging system, a topic management device, a messaging method, and program for solving the above-described problem that it is not easy to insert or remove a process when a specific message flow is formed among a plurality of processes.

### Means for Solving the Problems

The present invention has been made to solve the above-described problems and is a messaging system in which a publishing-side processing device which adds a topic to a message and transmit the message to a broker device and a subscribing-side processing device which designates the topic and receives the message from the broker device transmit and receive the message via the broker device, the messaging system including: a topic management device including a correspondence table storage unit which stores correspondence data which associates an abstract topic which is a topic described in a program with a real topic which is a topic which controls message transmission and reception for each process to be executed by each processing device, and a topic management service control unit which reads the correspondence data from the correspondence table storage unit and transmits the read correspondence data to each processing device, wherein each processing device includes: a topic lookup unit which receives the correspondence data from the topic management device; and a message processing unit which transmits and receives a message using the real topic corresponding to the abstract topic described in the program of a process to be executed based on the correspondence data received in the topic lookup unit.

In addition, the present invention is a topic management device in a messaging system in which a publishing-side processing device which adds a topic to a message and transmits the message to a broker device and a subscribing-side processing device which designates the topic and receives the message from the broker device transmit and receive the message via the broker device, the topic management device including: a correspondence table storage unit which stores correspondence data which associates an abstract topic which is a topic described in a program with a real topic which is a topic for controlling message transmission and reception for each process to be executed by each processing device; and a topic management service control unit which reads the correspondence data from the correspondence table storage unit, transmits the read correspondence data to each processing device, and causes each processing device to transmit and receive a message using the real topic corresponding to the abstract topic described in the program of a process to be executed.

In addition, the present invention is a messaging method in a messaging system in which a publishing-side processing device which adds a topic to a message and transmits the message to a broker device and a subscribing-side processing device which designates the topic and receives the message from the broker device transmit and receive the message via the broker device, the messaging method including: reading, by a topic management device, correspondence data from a correspondence table storage unit which stores the correspondence data which associates an abstract topic which is a topic described in a program with a real topic which is a topic for controlling message transmission and reception for each process to be executed by each processing device; transmitting the read correspondence data to each processing device; receiving, by each processing device, the correspondence data from the topic management device; and transmitting and receiving, by each processing device, a message using the real topic corresponding to the abstract topic described in the program of a process to be executed based on the received correspondence data.

In addition, the present invention is a messaging method in a messaging system in which a publishing-side processing device which adds a topic to a message and transmits the message to a broker device and a subscribing-side processing device which designates the topic and receives the message from the broker device transmit and receive the message via the broker device, the messaging method including: reading, by a topic management device, correspondence data from a correspondence table storage unit which stores the correspondence data which associates an abstract topic which is a topic described in a program with a real topic which is a topic for controlling message transmission and reception for each process to be executed by each processing device; and transmitting the read correspondence data to each processing device and causing each processing device to transmit and receive the message using the real topic corresponding to the abstract topic described in the program of a process to be executed.

In addition, the present invention is a program for causing a computer serving as a topic management device in a messaging system in which a publishing-side processing device which adds a topic to a message and transmits the message to a broker device and a subscribing-side processing device which designates the topic and receives the message from the broker device transmit and receive the message via the broker device to execute: a step of reading correspondence data from a correspondence table storage unit which stores the correspondence data which associates an abstract topic which is a topic described in a program with a real topic which is a topic for controlling message transmission and reception for each process to be executed by each processing device; and a step of transmitting the read correspondence data to each processing device and causing each processing device to transmit and receive the message using the real topic corresponding to the abstract topic described in the program of a process to be executed.

### Exemplary Advantage of the Invention

In the present invention, a process can be easily inserted or removed even when a specific message flow is formed among a plurality of processes.

### BRIEF DESCRIPTION OF DRAWINGS

FIG. 1 is a block diagram illustrating a configuration of a messaging system in accordance with an exemplary embodiment of the present invention.

FIG. 2 is a schematic diagram illustrating an example of a data structure and data of a correspondence table stored by a correspondence table storage unit in accordance with the present exemplary embodiment.

FIG. 3 is a flowchart illustrating a procedure of an insertion/deletion process in a topic management device in accordance with the present exemplary embodiment.

FIG. 4 is a flowchart illustrating a procedure of an insertion/deletion process in a processing device in accordance with the present exemplary embodiment.

FIG. 5 is an explanatory diagram describing details of the insertion process in the topic management device in accordance with the present exemplary embodiment.

FIG. 6 is an explanatory diagram describing details of the deletion process in the topic management device in accordance with the present exemplary embodiment.

FIG. 7 is a schematic diagram illustrating an outline of a Pub-Sub messaging model.

FIG. 8 is an explanatory diagram describing a problem in the Pub-Sub messaging model.

### MODES FOR CARRYING OUT THE INVENTION

Hereinafter, the modes for carrying out the present invention will be described in detail with reference to the drawings.

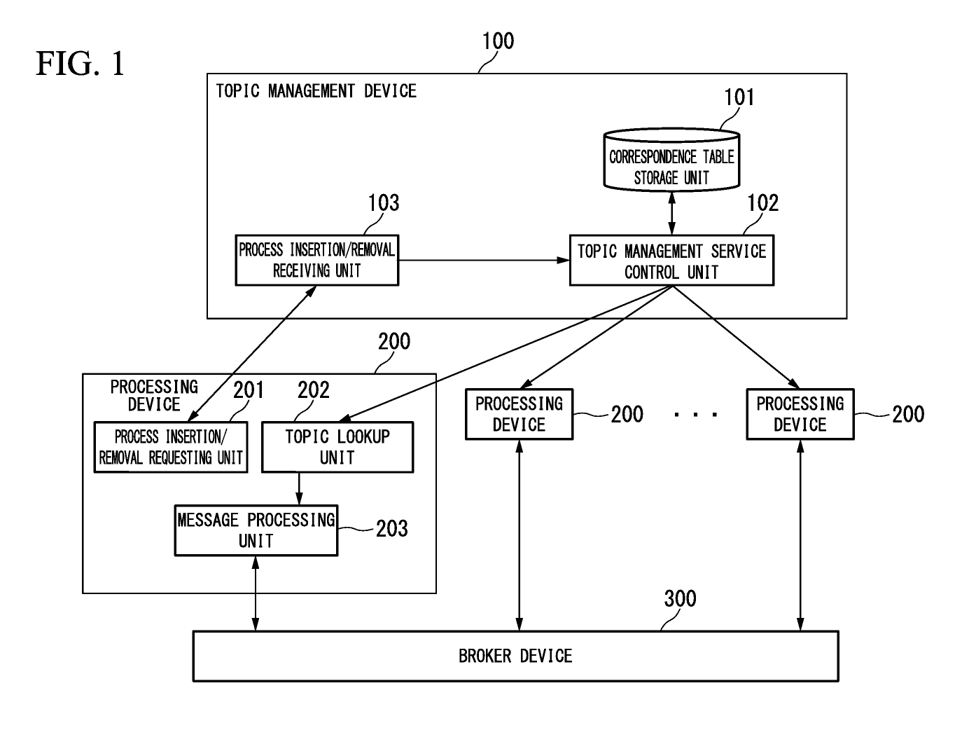

FIG. 1 is a block diagram illustrating a configuration of a messaging system in accordance with an exemplary embodiment of the present invention.

The present messaging system is a messaging system which realizes a Pub-Sub messaging model and is configured to include a topic management device 100, a plurality of processing devices 200, and a broker device 300. The present messaging system is a system in which a publishing-side processing device 200 (publisher) which adds a topic to a message and transmits the message to the broker device 300 and subscribing-sides processing devices 200 (subscribers) which designate topics and receive (subscribe to) the message from the broker device 300 transmit and receive the message via the broker device 300.

The broker device 300 is a server device for realizing asynchronous communication between the publishing-side processing device 200 and the subscribing-side processing devices 200. The broker device 300 has a queue corresponding to each process to be executed by each processing device 200. Upon receiving the message from the publishing-side processing device 200, the broker device 300 adds this message to the queue of a process which subscribes to a topic of this message. In addition, upon receiving a request for a message subscribed to in a process from the subscribing-side processing device 200, the broker device 300 extracts the message from the queue corresponding to this process and returns the extracted message to the subscribing-side processing device 200.

The topic management device 100 is a server device which manages a topic of a message flow formed by processes to be executed in the processing devices 200. The topic management device 100 is configured to include a correspondence table storage unit 101, a topic management service control unit 102, and a process insertion/removal receiving unit 103.

The correspondence table storage unit 101 stores a correspondence table representing correspondence data of each of processes to be executed by the processing devices 200. A specific message flow is formed among a plurality of processes to be executed by the plurality of processing devices 200. The correspondence data is data in which an abstract topic is associated with a real topic. The abstract topic is a topic which is descried in a program of each process. The real topic is a topic for controlling transmission and reception of a message.

The process insertion/removal receiving unit 103 receives a request for insertion or deletion of a process from the processing device 200 and outputs the received insertion or deletion request to the topic management service control unit 102. The insertion request is data for requesting the insertion of a process into the message flow, and includes an identifier of a process immediately before a process (hereinafter referred to as an insertion process) to be inserted into the message flow and an abstract topic of the insertion process. The deletion request is data for requesting the deletion of a process from the message flow and includes an identifier of a process (hereinafter referred to as a deletion process) to be deleted.

The topic management service control unit 102 updates correspondence data of each process in the correspondence table stored in the correspondence table storage unit 101 based on the input process insertion request or the input process deletion request. For example, when the process insertion request is input, the topic management service control unit 102 inserts correspondence data of the insertion process into the correspondence table and updates correspondence data of a process immediately before the insertion process in the message flow. Details of a method for updating the correspondence table at the time of process insertion will be described later. In addition, when the process deletion request is input, the topic management service control unit 102 deletes correspondence data of the deletion process from the correspondence table and updates correspondence data of the process immediately before the deletion process in the message flow. Details of a method for updating the correspondence table at the time of process deletion will be described later. In addition, when updating the correspondence table, the topic management service control unit 102 transmits a re-subscribe request to a topic lookup unit 202 of the processing device 200 which executes a process in which the correspondence data has been updated. The re-subscribe request is data for requesting re-reception of a message along with a notification indicating that the correspondence data has been updated, and includes the updated correspondence data. The topic management service control unit 102 reads the correspondence data from the correspondence table storage unit 101 and transmits the read correspondence data to the processing device 200, thereby causing the processing device 200 to transmit and receive a message using a real topic corresponding to an abstract topic described in a program of a process to be executed.

The processing device 200 is a publisher or subscriber which forms a message flow and is a device which executes one or a plurality of processes on a message which is received and transmitted. The processing device 200 is configured to include a process insertion/removal requesting unit 201, the topic lookup unit 202, and a message processing unit 203.

The process insertion/removal requesting unit 201 receives an input of the process insertion or process deletion request and transmits the input insertion or deletion request to the process insertion/removal receiving unit 103 of the topic management device 100.

The topic lookup unit 202 receives the re-subscribe request and performs a lookup of the real topic from the abstract topic based on correspondence data included in the received re-subscribe request. The lookup of the real topic from the abstract topic is conversion of the abstract topic described in the program of the process into the real topic. The topic lookup unit 202 then causes the message processing unit 203 to re-subscribe to the message using the looked-up real topic. The re-subscription is to re-subscribe to the message by re-notifying the broker device 300 of a topic of a message being subscribed to.

The message processing unit 203 transmits and receives a message using the real topic looked up in the topic lookup unit 202. Specifically, the message processing unit 203 executes a process of converting the abstract topic described in the program into the real topic and of transmitting and receiving a message. For example, the message processing unit 203 transmits a message to which the real topic is added to the broker device 300. In addition, the message processing unit 203 notifies the broker device 300 of a subscription to a message to which the real topic is added and receives the message to which the real topic is added from the broker device 300.

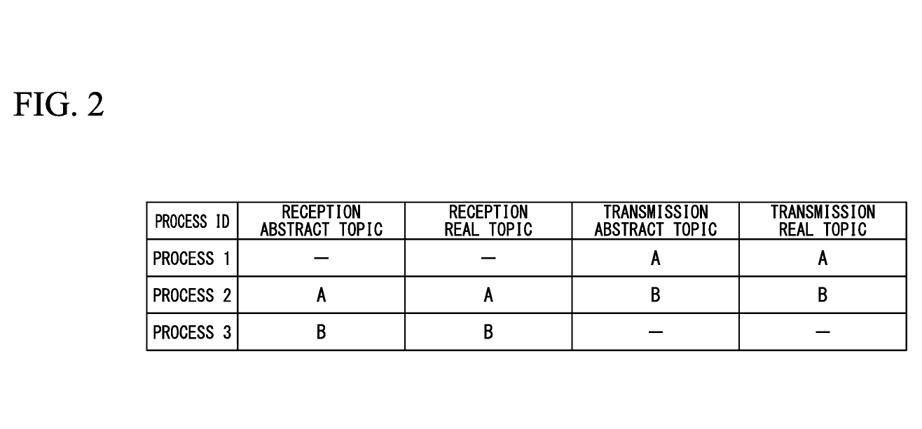

FIG. 2 is a schematic diagram illustrating an example of a data structure and data of a correspondence table stored by the correspondence table storage unit 101 in accordance with the present exemplary embodiment.

As illustrated, the correspondence table is data of a two-dimensional table format including rows and columns, and includes columns of items of a process ID (identifier), a reception abstract topic, a reception real topic, a transmission abstract topic, and a transmission real topic. The table includes a row for each process ID.

The process ID is an identifier for identifying each process. The transmission abstract topic is an abstract topic (for use in transmission) to be added to a message to be transmitted. The transmission real topic is a real topic (for use in transmission) to be added to a message to be transmitted. The reception abstract topic is an abstract topic (for use in reception) to be added to a message to be received (for which a subscription is made). The reception real topic is a real topic (for use in reception) to be added to a message to be received (for which a subscription is made). A set of a transmission abstract topic and a transmission real topic and a set of a reception abstract topic and a reception real topic are correspondence data.

In the example illustrated in FIG. 2, in the process 1, the reception abstract topic is “- (no topic),” the reception real topic is “-,” the transmission abstract topic is “A,” and the transmission real topic is “A.” That is, in the process 1, the topic “A” is added to the message and the message is transmitted. In addition, in the process 2, the reception abstract topic is “A,” the reception real topic is “A.” the transmission abstract topic is “B.” and the transmission real topic is “B.” That is, in the process 2, a message to which the topic “A” is added is received, a given process is applied to the received message, the topic “B” is added thereto, and the message is transmitted. In addition, in the process 3, the reception abstract topic is “B,” the reception real topic is “B,” the transmission abstract topic is “-,” and the transmission real topic is “-.” That is, in the process 3, a message to which the topic “B” is added is received.

Consequently, a message flow is formed in order of the process 1, the process 2, and the process 3.

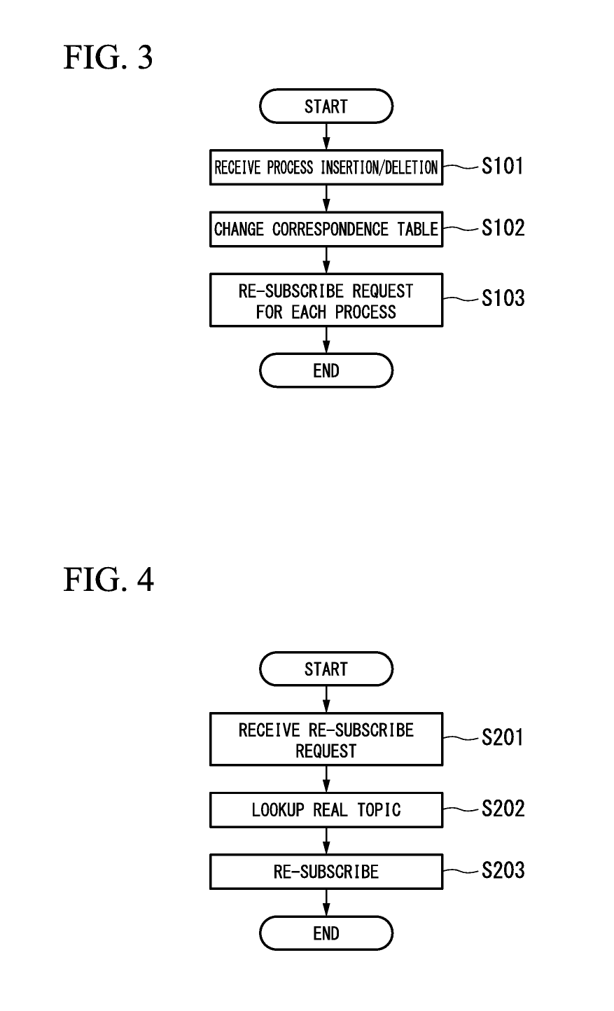

Next, the insertion/deletion process in the present messaging system will be described with reference to FIGS. 3 to 6. FIG. 3 is a flowchart illustrating a procedure of an insertion/deletion process in the topic management device 100 in accordance with the present exemplary embodiment.

First, the process insertion/removal receiving unit 103 receives a process insertion or deletion request from the process insertion/removal requesting unit 201 of the processing device 200 (step S101).

Next, the topic management service control unit 102 updates a correspondence table based on the process insertion or deletion request (step S102).

Next, the topic management service control unit 102 transmits a re-subscribe request to the topic lookup unit 202 of the processing device 200 which executes each process in which correspondence data is updated (step S103).

FIG. 4 is a flowchart illustrating a procedure of an insertion/deletion process in the processing device 200 in accordance with the present exemplary embodiment.

First, the topic lookup unit 202 receives the re-subscribe request from the topic management service control unit 102 of the topic management device 100 (step S201).

Next, the topic lookup unit 202 looks up a real topic from an abstract topic based on correspondence data included in the received re-subscribe request (step S202).

Then, the topic lookup unit 202 causes the message processing unit 203 to re-subscribe to a message using the looked-up real topic (step S203). The message processing unit 203 notifies the broker device 300 of a subscription of the reception real topic and receives a message to which the reception real topic is added.

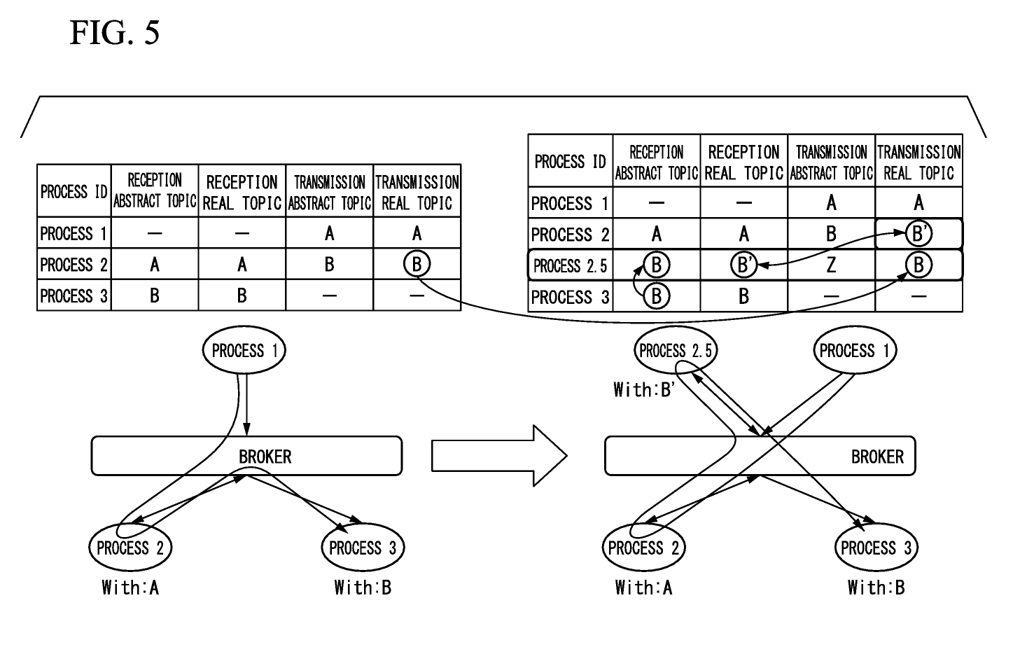

FIG. 5 is an explanatory diagram describing details of the insertion process in the topic management device 100 in accordance with the present exemplary embodiment.

Hereinafter, an example in which a process 2.5 is inserted into a message flow including the processes 1 to 3 illustrated in FIG. 2 will be described.

In FIG. 5, a schematic diagram illustrating a data example of a correspondence table and a message flow before the process 2.5 is inserted is illustrated on the left side of an arrow.

The data example of the correspondence data illustrated in FIG. 5 is the same as the data example of the correspondence data illustrated in FIG. 2. That is, the message flow before the process 2.5 is inserted is formed in order of the process 1, the process 2, and the process 3.

In FIG. 5, a schematic diagram illustrating a data example of a correspondence table and a message flow after the process 2.5 is inserted is illustrated on the right side of the arrow.

The process 2.5 is inserted between the process 2 and the process 3. That is, the message flow after the process 2.5 is inserted is formed in order of the process 1, the process 2, the process 2.5, and the process 3.

The topic management service control unit 102 receives a process insertion request including an identifier of the process 2 immediately before the inserted process 2.5 and a transmission abstract topic “Z” of the inserted process 2.5. In the correspondence data of the process 2.5, the topic management service control unit 102 designates the reception abstract topic as a reception abstract topic “B” of the immediately following process 3, designates the reception real topic as an arbitrary value “B′” different from the others, designates the transmission abstract topic as the received transmission abstract topic “Z,” and designates the transmission real topic as transmission real topic “B” of the process 2. Next, the topic management service control unit 102 designates the transmission real topic of the immediately previous process 2 as reception real topic “B′” of the process 2.5.

In this way, when the replacement of the topics in the correspondence table is performed, it is possible to insert a process into a message flow without message loss.

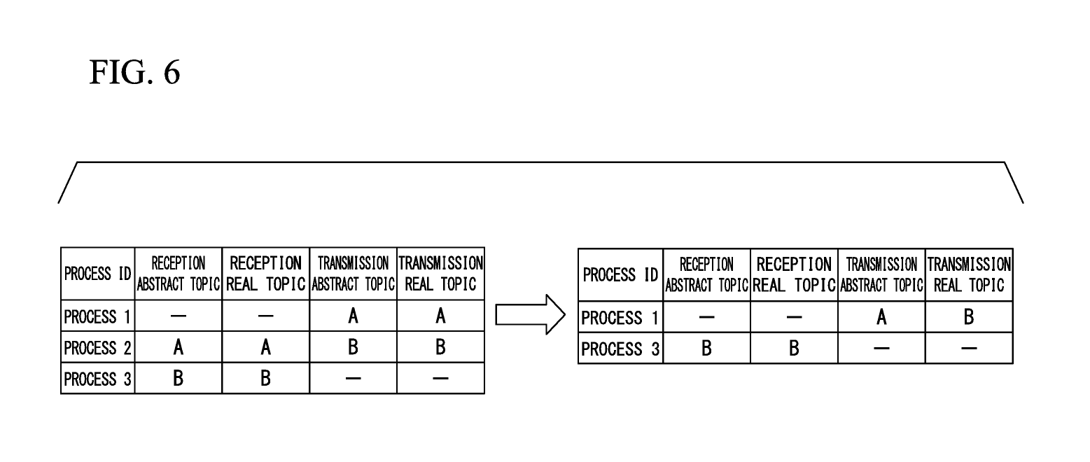

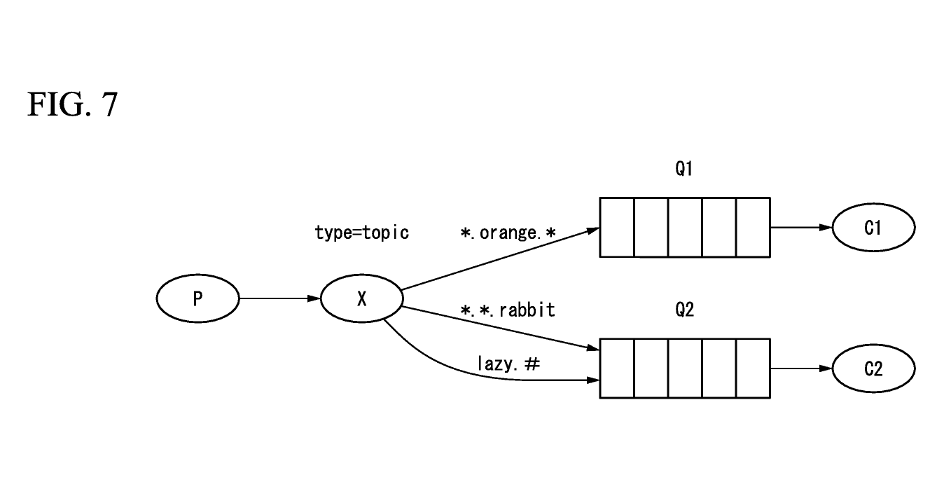

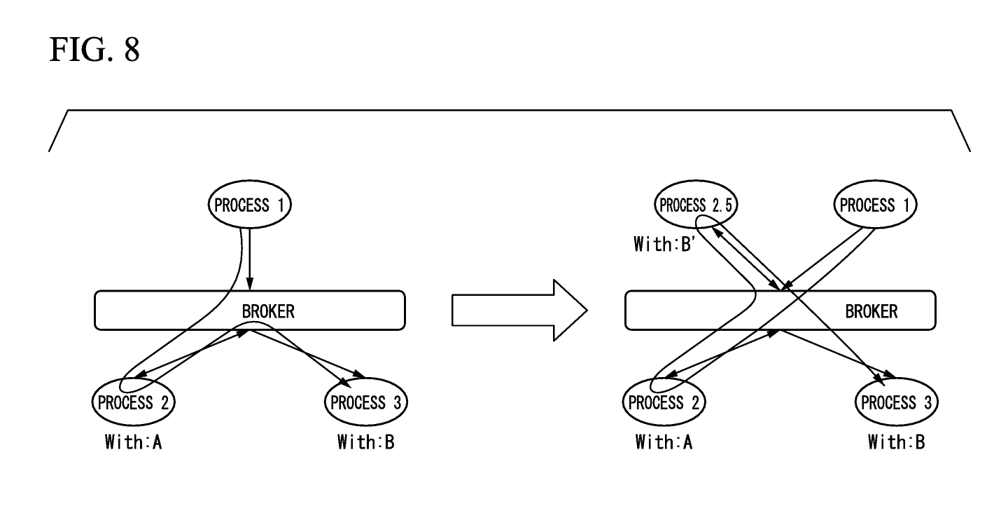

FIG. 6 is an explanatory diagram describing details of the deletion process in the topic management device 100 in accordance with the present exemplary embodiment.

Hereinafter, an example in which the process 2 is deleted from the message flow including the processes 1 to 3 illustrated in FIG. 2 will be described.

In FIG. 6, a schematic diagram illustrating a data example of a correspondence table before the process 2 is deleted is illustrated on the left side of an arrow.

The data example of the correspondence data illustrated in FIG. 6 is the same as the data example of the correspondence data illustrated in FIG. 2. That is, the message flow before the process 2 is deleted is formed in order of the process 1, the process 2, and the process 3.

In FIG. 6, a schematic diagram illustrating a data example of a correspondence table after the process 2 is deleted is illustrated on the right side of the arrow.

The message flow after the process 2 is deleted is formed in order of the process 1 and the process 3.

The topic management service control unit 102 receives a process deletion request including the identifier of the process 2 to be deleted. The topic management service control unit 102 changes the transmission real topic of the process 1 immediately before the process 2 to be deleted to a transmission real topic “B” of the process 2 to be deleted and deletes correspondence data of the process 2 to be deleted from the correspondence table. Here, the value of a transmission real topic of the process 1 immediately before the process 2 to be deleted in the message flow represents the same process of the reception real topic “A” of the process 2 to be deleted.

In this way, when the replacement of the topic in the correspondence table is performed, it is possible to delete a process from a message flow without message loss.

It is to be noted that, in this example, while the topic management service control unit 102 changes the transmission real topic of the process 1 immediately before the process 2 to be deleted when the process 2 is deleted, a reception real topic of the process 3 immediately after the process to be deleted may be set to the reception real topic “A” of the process 2 to be deleted. Here, the value of the reception real topic of the process 3 immediately after the process 2 to be deleted in the message flow represents the same process of the transmission real topic “B” of the process 2 to be deleted.

In this manner, in the present exemplary embodiment, the topic management device 100 abstracts and manages a topic for controlling delivery of a message. Then, the processing device 200 converts an abstract topic designated in the program into a real topic and the message delivery is controlled by the real topic. Thereby, the insertion and removal of a process for the message flow can be realized by correcting the correspondence from the abstract topic to the real topic. Thus, when a message flow is formed among a plurality of processes, it is possible to realize the insertion and removal of a process without changing source codes or the like. That is, it is possible to easily insert or remove a process even when a message flow is formed among a plurality of processes.

It is to be noted that the present messaging system can abstract a topic even when the topic management device 100 is configured to only include the correspondence table storage unit 101 and the topic management service control unit 102 and the processing device 200 is configured to only include the topic lookup unit 202 and the message processing unit 203. Thus, with only this configuration, it is possible to obtain an exemplary advantage that the insertion and removal of a process can be realized without changing source codes or the like and it is possible to solve a problem that the insertion and removal of a process are not easy when a specific message flow is formed among a plurality of processes.

Although the exemplary embodiments of the present invention have been described above in detail with reference to the drawings, specific configurations are not limited to the exemplary embodiments, and designs and the like without departing from the gist of the present invention may also be included.

For example, although a messaging system using a topic has been described in the above-described exemplary embodiments, the present invention is also applicable to a distributed system which controls a data and/or message flow based on information embedded in a program, a setting file, or the like.

Also, a process of inserting/deleting a process may be performed by recording a program for realizing each step illustrated in FIG. 3 or FIG. 4 on a computer-readable recording medium and causing a computer system to read and execute the program recorded on the recording medium. It is to be noted that the “computer system” referred to here may include an operating system (OS) and hardware such as peripheral devices.

In addition, the “computer system” also includes a homepage providing environment (or displaying environment) when a World Wide Web (WWW) system is used.

In addition, the “computer-readable recording medium” refers to a storage device including a flexible disk, a magneto-optical disc, a read only memory (ROM), a writable non-volatile memory such as a flash memory, a portable medium such as a compact disc-ROM (CD-ROM), and a hard disk embedded in the computer system.

Furthermore, the “computer-readable recording medium” includes a medium which stores a program for a fixed period of time like a volatile memory (e.g., dynamic random access memory (DRAM)) inside a computer system serving as a server or a client when the program is transmitted via a network such as the Internet or a communication circuit such as a telephone circuit.

In addition, the above-described program may be transmitted from the computer system storing the program in a storage device or the like to other computer systems via a transmission medium or transmission waves of the transmission medium. Here, the “transmission medium” for transmitting the program refers to a medium having a function of transmitting information like a network (communication network) such as the Internet or a communication circuit (communication line) such as a telephone circuit.

In addition, the above-described program may be a program which realizes some of the above-described functions. Furthermore, the program may be a so-called differential file (differential program) capable of realizing the above-described functions in combination with a program already recorded on the computer system.

This application is based upon and claims the benefit of priority from Japanese Patent Application No. 2012-069899, filed on Mar. 26, 2012, the disclosure of which is incorporated herein in its entirety by reference.

### INDUSTRIAL APPLICABILITY

The present invention is applicable to, for example, a system which forms a data or message flow among a plurality of processes. In the present invention, process insertion and removal are facilitated even when a specific message flow is formed among the plurality of processes.

### DESCRIPTION OF REFERENCE SIGNS

100 Topic management device
101 Correspondence table storage unit
102 Topic management service control unit
103 Process insertion/removal receiving unit
200 Processing device
201 Process insertion/removal requesting unit
202 Topic lookup unit
203 Message processing unit
300 Broker device

1. A messaging system in which a publishing-side processing device which adds a topic to a message and transmit the message to a broker device and a subscribing-side processing device which designates the topic and receives the message from the broker device transmit and receive the message via the broker device, the messaging system comprising:
a topic management device including
a correspondence table storage unit which stores correspondence data which associates an abstract topic which is a topic described in a program with a real topic which is a topic which controls message transmission and reception for each process to be executed by each processing device, and
a topic management service control unit which reads the correspondence data from the correspondence table storage unit and transmits the read correspondence data to each processing device,
wherein each processing device comprises:
a topic lookup unit which receives the correspondence data from the topic management device; and
a message processing unit which transmits and receives a message using the real topic corresponding to the abstract topic described in the program of a process to be executed based on the correspondence data received in the topic lookup unit.

2. The messaging system according to claim 1,
wherein the topic management device comprises:
a process insertion/removal receiving unit which receives an insertion request which is data for requesting insertion of a process or a deletion request which is data for requesting deletion of a process, and
wherein the topic management service control unit updates the correspondence data of each process stored in the correspondence table storage unit based on the insertion request or the deletion request received in the process insertion/removal receiving unit.

3. The messaging system according to claim 2, wherein the topic management service control unit transmits a re-subscribe request which is data for requesting message re-reception and which includes updated correspondence data when the correspondence data stored in the correspondence table storage unit is updated.

4. The messaging system according to claim 2, wherein
the process insertion/removal receiving unit receives the insertion request including an identifier of a process immediately previous to a process to be inserted, and
when the insertion request is received in the process insertion/removal receiving unit, the topic management service control unit replaces a transmission real topic which is a real topic for use in transmission of the process to be inserted with a transmission real topic of a process immediately previous to the process to be inserted, replaces a reception real topic which is a real topic for use in reception of the process to be inserted with a value different from other real topics, and replaces the transmission real topic of the process immediately previous to the process to be inserted with the reception real topic of the process to be inserted.

5. The messaging system according to claim 2, wherein
the process insertion/removal receiving unit receives the deletion request including an identifier of a process to be deleted, and
when the deletion request is received in the process insertion/removal receiving unit, the topic management service control unit deletes correspondence data of the process to be deleted from the correspondence table storage unit and replaces a transmission real topic which is a real topic for use in transmission of a process immediately previous to the process to be deleted with a transmission real topic of the process to be deleted.

6. A topic management device in a messaging system in which a publishing-side processing device which adds a topic to a message and transmits the message to a broker device and a subscribing-side processing device which designates the topic and receives the message from the broker device transmit and receive the message via the broker device, the topic management device comprising:
a correspondence table storage unit which stores correspondence data which associates an abstract topic which is a topic described in a program with a real topic which is a topic for controlling message transmission and reception for each process to be executed by each processing device; and
a topic management service control unit which reads the correspondence data from the correspondence table storage unit, transmits the read correspondence data to each processing device, and causes each processing device to transmit and receive a message using the real topic corresponding to the abstract topic described in the program of a process to be executed.

7. (canceled)

8. A messaging method in a messaging system in which a publishing-side processing device which adds a topic to a message and transmits the message to a broker device and a subscribing-side processing device which designates the topic and receives the message from the broker device transmit and receive the message via the broker device, the messaging method comprising:
reading, by a topic management device, correspondence data from a correspondence table storage unit which stores the correspondence data which associates an abstract topic which is a topic described in a program with a real topic which is a topic for controlling message transmission and reception for each process to be executed by each processing device; and
transmitting the read correspondence data to each processing device and causing each processing device to transmit and receive the message using the real topic corresponding to the abstract topic described in the program of a process to be executed.

9. (canceled)

10. The messaging system according to claim 3, wherein
the process insertion/removal receiving unit receives the insertion request including an identifier of a process immediately previous to a process to be inserted, and
when the insertion request is received in the process insertion/removal receiving unit, the topic management service control unit replaces a transmission real topic which is a real topic for use in transmission of the process to be inserted with a transmission real topic of a process immediately previous to the process to be inserted, replaces a reception real topic which is a real topic for use in reception of the process to be inserted with a value different from other real topics, and replaces the transmission real topic of the process immediately previous to the process to be inserted with the reception real topic of the process to be inserted.

11. The messaging system according to claim 3, wherein
the process insertion/removal receiving unit receives the deletion request including an identifier of a process to be deleted, and
when the deletion request is received in the process insertion/removal receiving unit, the topic management service control unit deletes correspondence data of the process to be deleted from the correspondence table storage unit and replaces a transmission real topic which is a real topic for use in transmission of a process immediately previous to the process to be deleted with a transmission real topic of the process to be deleted.

12. The messaging system according to claim 4, wherein
the process insertion/removal receiving unit receives the deletion request including an identifier of a process to be deleted, and
when the deletion request is received in the process insertion/removal receiving unit, the topic management service control unit deletes correspondence data of the process to be deleted from the correspondence table storage unit and replaces a transmission real topic which is a real topic for use in transmission of a process immediately previous to the process to be deleted with a transmission real topic of the process to be deleted.

13. The messaging system according to claim 10, wherein
the process insertion/removal receiving unit receives the deletion request including an identifier of a process to be deleted, and
when the deletion request is received in the process insertion/removal receiving unit, the topic management service control unit deletes correspondence data of the process to be deleted from the correspondence table storage unit and replaces a transmission real topic which is a real topic for use in transmission of a process immediately previous to the process to be deleted with a transmission real topic of the process to be deleted.
